(19) United States
(12) Patent Application Publication
(10) Pub. No.: US 2011/0094710 A1
(43) Pub. Date: Apr. 28, 2011

(54) REDUNDANT EMITTER ELECTRODES IN AN ION WIND FAN

(75) Inventors: Ashwini CHOUDHARY, San Jose, CA (US); Anil Khubchandani, San Jose, CA (US)

(73) Assignee: VENTIVA, INC., Santa Clara, CA (US)

(21) Appl. No.: 12/605,155

(22) Filed: Oct. 23, 2009

(51) Int. Cl. F28F 13/16; F28F 27/00; H01T 23/00

(52) U.S. Cl. 165/96; 165/104.34; 361/231

(57) ABSTRACT

Emitter electrodes of ion wind fans can operate at high voltages in ionized environments. This can lead to degradation of the emitter electrodes over time. In one embodiment, the present invention provides an ion wind fan having a primary emitter electrode, and a redundant emitter electrode. The primary emitter electrode and the redundant emitter electrode are never simultaneously operational.

### FIELD OF THE INVENTION

The present invention is related to ion wind fans, and more particularly to methods and apparatuses related to managing emitter electrode degradation in an ion wind fan.

### BACKGROUND

It is well known that heat can be a problem in many electronics device environments, and that overheating can lead to failure of components such as integrated circuits (e.g. a central processing unit (CPU) of a computer) and other electronic components. Heat sinks are a common device used to prevent overheating. Heat sinks rely mainly on the dissipation of heat from the device using air. To increase the heat dissipation of a heat sink, a conventional rotary fan has been used to move air across the surface of the heat sink. Conventional fans have many disadvantages when used in consumer electronics products, such as noise, weight, size, and failure of moving parts and bearings. A solid-state fan using ion wind, also known as corona wind, to move air addresses the disadvantages of conventional fans. However, providing an ion wind fan that meets the requirements of consumer electronics devices presents numerous challenges not addressed by any currently existing ionic wind device.

One problem of currently existing ion wind devices is degradation of the high-voltage emitter electrodes due to dust and silicon dioxide deposition. Such contamination or corrosion of the emitter electrodes can lead to sparking, decreased performance, or even total emitter failure.

### BRIEF DESCRIPTION OF THE DRAWINGS

FIG. 1 is a block diagram illustrating an ion wind fan implemented as part of thermal management of an electronic device;

FIG. 2 is a block diagram illustrating an ion wind fan having redundant emitter electrodes according to one embodiment of the present invention;

FIG. 3 is a block diagram illustrating a primary/secondary emitter pair according to one embodiment of the present invention;

FIG. 4 is a block diagram illustrating multiple primary and redundant emitter electrodes and one high voltage switch according to another embodiment of the present invention;

FIG. 5 is a block diagram illustrating a performance feedback mechanism according to one embodiment of the present invention;

FIG. 6 is a frontal view plan diagram illustrating an ion wind fan having wire emitter electrodes according to an embodiment of the present invention;

FIG. 7 is a flow diagram illustrating a process for switching from a primary to a redundant emitter electrode according to one embodiment of the present invention.

### DETAILED DESCRIPTION

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not necessarily be so limited; rather the principles thereof can be extended to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

Ion wind or corona wind generally refers to the gas flow that is established between two electrodes, one sharp and the other blunt, when a high voltage is applied between the electrodes. The air is partially ionized in the region of high electric field near the sharp electrode. The ions that are attracted to the more distant blunt electrode collide with neutral (uncharged) molecules en route to the collector electrode and create a pumping action resulting in air movement. The high voltage sharp electrode is generally referred to as the emitter electrode or corona electrode, and the grounded blunt electrode is generally referred to as the counter electrode or collector electrode.

The general concept of ion wind—also sometimes referred to as ionic wind and corona wind even though these concepts are not entirely synonymous—has been known for some time. For example, U.S. Pat. No. 4,210,847 to Shannon, et al., dated Jul. 1, 1980, titled “Electric Wind Generator” describes a corona wind device using a needle as the sharp corona electrode and a mesh screen as the blunt collector electrode. The concept of ion wind has been implemented in relatively large-scale air filtration devices, such as the Sharper Image Ionic Breeze.

### Example Ion Wind Fan Thermal Management Solution

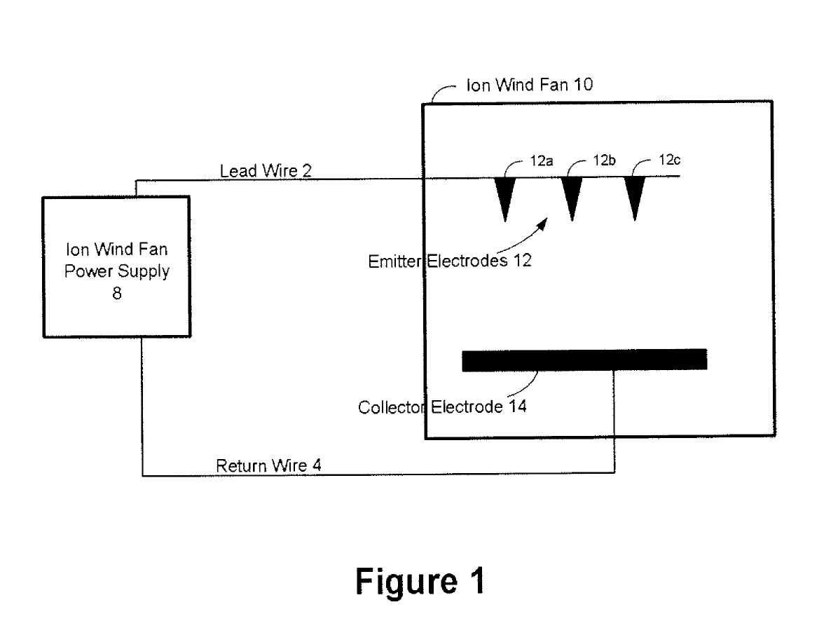

FIG. 1 illustrates an ion wind fan 10 used as part of a thermal management solution for an electronic device. The electronic device may need thermal management for an integrated circuit—such as a chip or a processor—that produces heat, or some other heat source, such as a light emitting diode. Some example systems that can use an ion wind thermal management solution include computers, laptops, gaming devices, projectors, television sets, set-top boxes, servers, NAS devices, memory devices, LED lighting devices, LED display devices, smart-phones, music players and other portable devices, and generally any device having a heat source requiring thermal management.

The electronic device system will have a system power supply (not shown). For example, in the case of a laptop computer, the laptop will have a system power supply such as a battery that provides electric power to the electronic components of the laptop. In the case of a wall-plug device such as a gaming device or television set, the system power supply 30 will convert the 110V AC (in the U.S.A.) current from an electrical outlet into the appropriate voltage and type of current. For example, system power supply 30 of a projector would likely convert power from the outlet into approximately 3 kV-5 kV DC or equivalent AC.

The electronic device also includes a heat source (not shown), and can also include a passive thermal management element, such as a heatsink (also not shown). To assist in heat transfer, an ion wind fan 10 is provided in the system to help move air across the surface of the heat source or the heatsink. In prior art systems, conventional rotary fans with rotating fan blades have been used for this purpose.

As discussed above, the ion wind fan 10 operates by creating a high electric field around one or more emitter electrodes 12 resulting in the generation of ions, which are then attracted to a collector electrode 14. In FIG. 1, the emitter electrodes 12 are represented as triangles as an illustration that they are generally “sharp” electrodes. However, in a real-world ion wind fan 10, the emitter electrodes 12 can be implemented as wires, shims, blades, pins, and numerous other geometries. Furthermore, while there are three emitter electrodes (12a, 12b, 12c) are shown in FIG. 1, embodiments of the present invention can be implemented with any number of emitter electrodes 12.

Similarly, the collector electrode 14 is shown simply as a plate in FIG. 1. However, a real-world collector electrode 14 can have various shapes and will most likely include openings to allow the passage of air. The collector electrode 14 can also be implemented as multiple collector electrodes held at substantially the same potential. Since the specific emitter 12 and collector 14 geometries are not germane to the present invention, they are illustrated as triangles and plates for simplicity and ease of understanding. Furthermore, in a real world ion wind fan 10, the emitter electrodes 12, the collector electrode 14, or both would be disposed on a dielectric chassis—sometimes referred to as an isolator element—that has also been omitted from FIG. 1 for simplicity and ease of understanding.

To create the high electric field necessary for ion generation, the ion wind fan 10 is connected to an ion wind power supply 20. The ion wind power supply 20 is a high-voltage power supply that can apply a high voltage potential across the emitter electrodes 12 and the collector electrode 14. The ion wind fan power supply 20 (hereinafter sometimes referred to as “IWFPS”) is electrically coupled to and receives electrical power from the system power supply or an outlet. Usually for electronic devices, the system power supply provides low-voltage direct current (DC) power. For example, a laptop computer system power supply would likely output approximately 5-12V DC, while the power supply for an LED light fixture would likely output approximately 50-200V DC.

To provide the high voltage necessary to drive the ion wind fan 10, in one embodiment, the IWFPS 8 converts the received low-voltage DC power to AC using a DC/AC converter, and uses a transformer to step up the resulting AC voltage to a desired high voltage. The stepped-up voltage is then provided to a rectifier to convert to a high-voltage DC potential. The IWFPS 8 can be implemented in a variety of ways, and since the specifics of the IWPS 20 are not germane to the embodiments of the present invention, the IWFPS 8 will only be represented as a block, and will only be shown to include modules that are related to the various embodiments of the present invention for simplicity and ease of understanding.

The high voltage DC terminal of the IWFPS 8 is then electrically coupled to the emitter electrodes 12 of the ion wind fan 10 via a lead wire 2. The collector electrode 14 is connected back to the IWFPS 8 via return/ground wire 4, to ground the collector electrode 14 thereby creating a high voltage potential across the emitters 12 and the collector 14 electrodes. The return wire 4 can be connected to a system, local, or absolute high-voltage ground using conventional techniques.

While the system shown in and described with reference to FIG. 1 uses a positive DC voltage to generate ions, ion wind can be created using AC voltage, or by connecting the emitters 12 to the negative terminal of the IWFPS 8 resulting in a “negative” corona wind. Embodiments of the present invention are not limited to positive DC voltage ion wind. Furthermore, while the IWFPS 8 is described as receiving power from a system power supply, the IWFPS 8 can receive power directly from an outlet.

### Redundant Emitter Electrodes

As described partially above, ion wind is generated by the ion wind fan 10 by applying a high voltage potential across the emitter 12 and collector 14 electrodes. This creates a strong electric field around the emitter electrodes 12, strong enough to ionize the air in the vicinity of the emitter electrodes 12 in effect creating a plasma region. The ions are attracted to collector electrode 12, and as they traverse air gap along the electric field lines, the ions bump into neutral air molecules, creating airflow. On a real world collector electrode 14, air passage openings (not shown) allow the airflow to pass through the collector 14 thus creating an ion wind fan.

However, the high electric field around the emitter electrodes 12 also attracts charged dust particles and silicon dioxide from the ambient air. As dust and silicon dioxide get deposited on the emitter electrode, the geometry of the emitter can change causing sparking, decreased performance, and other problems. Various cleaning solutions for emitter electrodes have been developed to address these and related issues. However, these cleaning techniques can add cost and complexity to ion wind fans. Furthermore, emitter electrodes 12, especially when implemented as thin wires, can be prone to failure because of other issues, such as sagging due to thermal expansion, breaking, and various other failure modes.

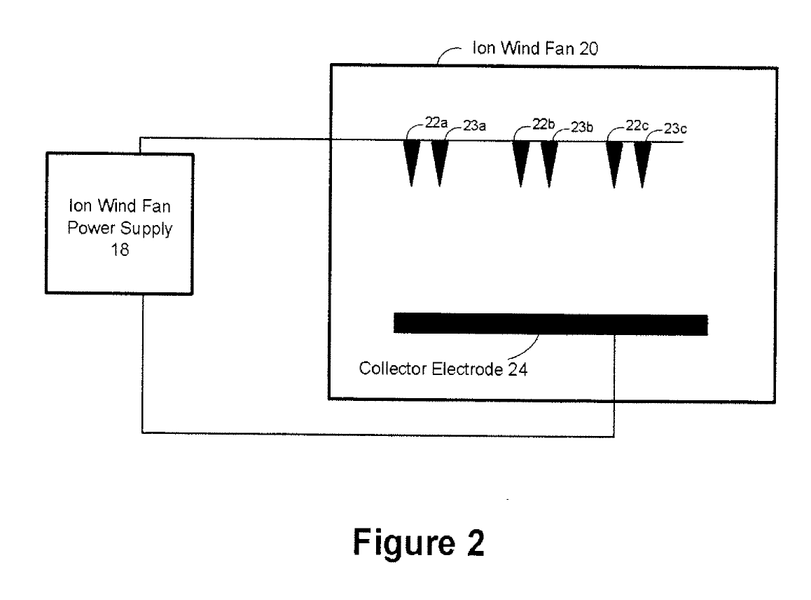

To address these and other problems, and to extend the life of an ion wind fan, in one embodiment, redundant emitter electrodes are provided. One embodiment of such an ion wind fan is now described with reference to FIG. 2. Some of the components and elements shown in FIG. 2 are substantially the same as those described with reference to FIG. 1, and therefore will not be described again.

FIG. 2 is a block diagram of an ion wind fan 20 having redundant emitter electrodes. In addition to three primary emitter electrodes 22a-c, there are also three redundant (also sometimes referred to herein as “secondary”) emitter electrodes 23a-c. Thus, each primary emitter electrode, such as 22b, has an associated redundant emitter electrode, in this case 23b.

For a primary/redundant electrode pair, only one is operational at any time when the fan is operational. For example, either emitter electrode 22c is receiving the high voltage DC from the IWFPS 18 or redundant emitter electrode 23c is receiving the high voltage DC from the IWFPS 18, but not both at the same time. Thus, in one embodiment, if one of the primary emitter electrodes 22 fails or becomes compromised, it is disconnected from the IWFPS 8 and its associated redundant emitter electrode 23 becomes operational. While in FIG. 2, each primary emitter electrode 22 has one associated redundant emitter electrode 23, in another embodiment, multiple redundant (backup) emitter electrodes can be associated with each primary emitter electrode 22.

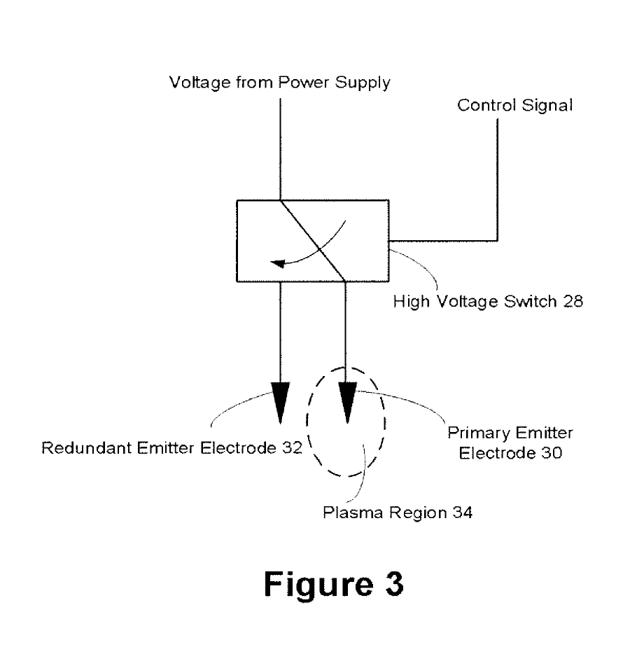

FIG. 3 is a block diagram illustrating a high voltage switch 28 configured to switch power from the IWFPS 18 between a primary emitter electrode 30 and a redundant emitter electrode 32. The high voltage switch 28 receives a control signal from a switch controller—i.e. switch control circuit—that may or may not be part of the IWFPS 18. The control signal operates the switch 28. As shown in FIG. 3, the switch 28 selects between two output lines, but in other embodiments, there can be multiple outputs from which to select, each output line configured to deliver power to an emitter electrode. In other words, multiple redundant emitter electrodes can be used.

The high voltage switch 28 can be implemented in a variety of ways. In one embodiment, multiple optical couplers are arranged to create a switch. The optical couplers can be selected, for example, from the OC-100 family of opto-couplers available from Voltage Multipliers, Inc. The arranging two opto-couplers in parallel, a high voltage switch can be constructed. An opto-coupler is a high voltage diode that allows current flow based on a light input, which can be provided by light emitting diodes (LEDs). Other possibilities for the high voltage switch 28 include mechanical switches, electromechanical relays, and other such high-voltage switching devices.

FIG. 3 further illustrates, that in one embodiment, the redundant emitter electrode 32 is positioned outside of the plasma region 34 that surrounds the primary emitter electrode 30. As explained further above, the plasma region 34 is the area surrounding an emitter electrode where the electric field is strong enough to generate ions from air molecules either through direct ionization of as a result of an electron avalanche. The area of the plasma region 34 is a function of emitter geometry, operating voltage, the air gap separating the emitter and collector electrodes, and other ion wind fan-specific operating parameters. However, the plasma region 34 tends to be relatively small in relation to the total area of the ion win fan 20. For example, for a 50 microns diameter wire emitter electrode operating at approximately 4 kV, the plasma region 34 is approximately 150 microns in diameter surrounding the wire emitter electrode.

When directed by the control signal to switch between emitter electrodes, the high voltage power supply 28 switches power delivery from the primary emitter electrode 30 to the redundant emitter electrode 32. This causes secession of ion generation by the primary emitter electrode 30, and the plasma region 34 will no longer contain plasma. However, since the redundant emitter electrode is now provided with the high voltage potential, it will ionize the air in its vicinity, creating ions and plasma in a new plasma region surrounding the redundant emitter electrode 32.

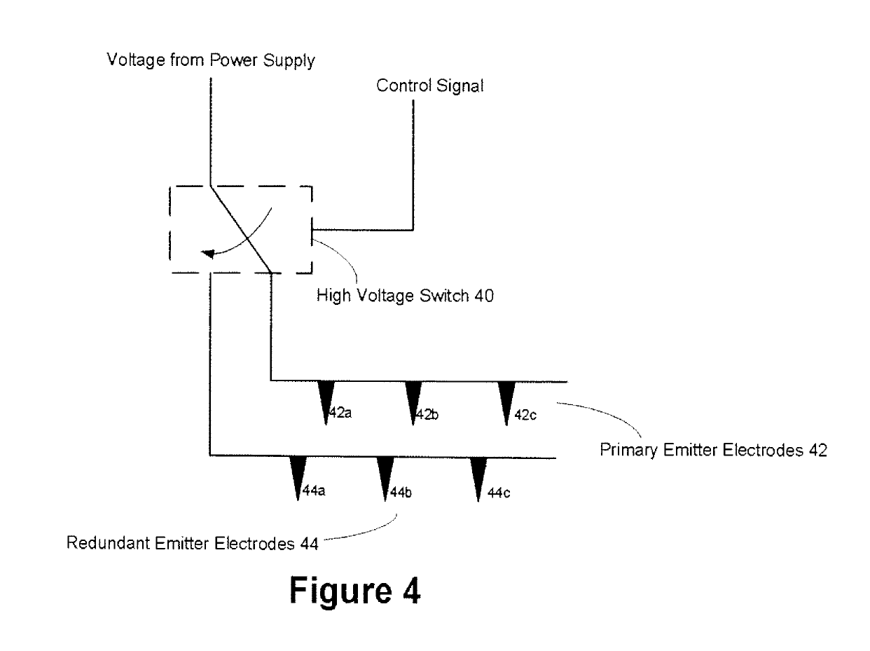

As illustrated in FIG. 3, the high voltage switch 28 can switch between one primary emitter and its associated redundant emitter. However, in another embodiment now described with reference to FIG. 4, a high voltage switch 40 can be configured to switch between a set of primary emitter electrodes 42 and a set of redundant emitter electrodes 44. In FIG. 4, either the set of primary emitter electrodes 42 is operational or the set of redundant emitter electrodes 44 is operational. In the embodiment illustrated in FIG. 4, the high voltage switch 40 is not configured to only switch one individual primary emitter electrode to its associated redundant emitter electrode; instead, the switch 40 is configured to select either all primary 42 or all redundant emitter electrodes 44.

The illustration in FIG. 4 is an abstraction, and in a real-world ion wind fan 20 the associated emitters—for example primary emitter 42c and redundant emitter 44c—would be in close proximity according to one embodiment of the present invention. However, associated emitter electrodes—associated emitter electrodes being defined generally as a set of emitter electrodes of which only one is operational at any given time—need not be located in close proximity. In one embodiment, the only restraint on the placement of emitter electrodes, is that emitter electrodes should not be placed in the plasma region of another emitter electrode that may be operational at the same time.

In parts of the preceding descriptions, electrodes have been identified as primary and secondary. However, a “primary” emitter electrode simply means the emitter electrode that is currently operational. For example, if multiple redundant emitter electrodes are used, then, once the initial primary electrode has been turned off in favor of one of the redundant emitter electrodes, this newly operational redundant emitter electrode in effect becomes the new “primary” emitter electrode so long as additional redundant emitter electrodes remain.

Phrased another way, the ion wind fan 20 has multiple sets of emitter electrodes; for example, ion wind fan 20 of FIG. 2 has three sets of two emitter electrodes. In one embodiment, at most one emitter electrode of each set of operational at any given time. In FIG. 2, each set of emitters contains two emitter electrodes, thus making the naming convention of primary/redundant convenient. However, such emitter electrode sets can have more than two electrodes each.

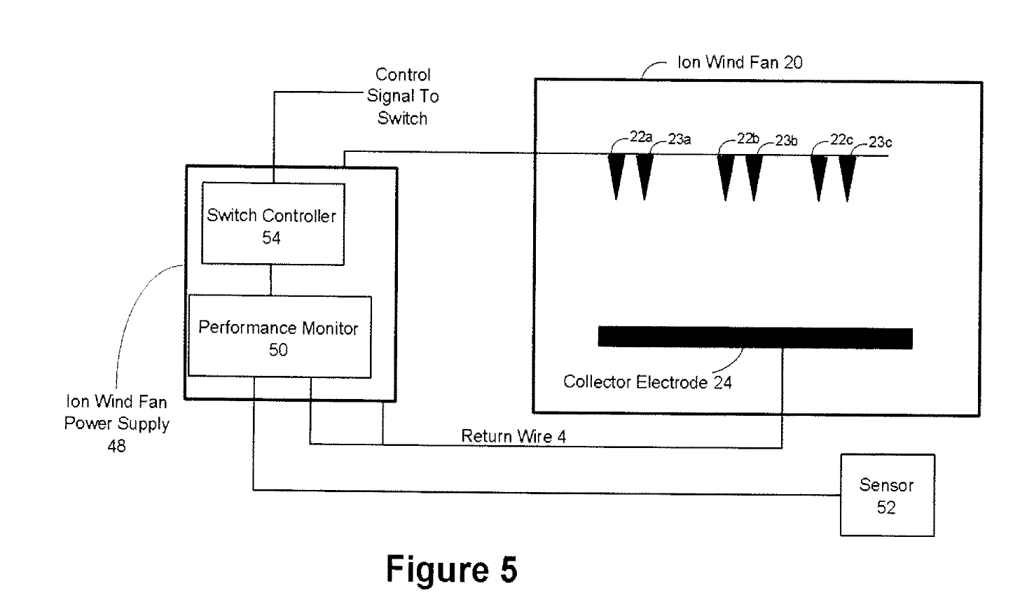

In the discussions related to FIGS. 3 and 4, the control signal operating the high voltage switches 28 and 40 have been mentioned. One embodiment of the origination of such a control signal is now described with reference to FIG. 5. In one embodiment, the return wire 4 is not only used to ground the collector electrode 24 at the IWFPS 48, but it is also tapped as an input for a performance monitor 50 module. Furthermore, the system using the ion wind fan thermal management solution can also include a sensor 52, that also provides input data for the performance monitor 50 module.

The performance monitor 50 can be implemented as a circuit, software, firmware, or a combination of hardware and software components. In one embodiment, the performance monitor 50 measures the current across the ion wind fan 20—i.e., the ionic current flowing from the emitter electrodes 22 to the collector electrode 24. When the current drops below a certain threshold for a threshold period of time, the performance monitor 50 interprets the decrease in current as low performance due to emitter degradation, and directs the switch controller 54 to switch from the primary emitter electrodes 22a-c to the redundant emitter electrodes 23a-c.

In another embodiment, instead of or in addition to—the current across the ion wind fan 20, the performance monitor 50 also monitors the voltage across the ion wind fan 20. In some embodiments, the voltage provided by the power supply 48 is dynamically adjusted to maintain performance. If the voltage rises above a certain threshold, and remains above this threshold for longer than a predetermined time period, then the performance monitor 50 interprets the increase in voltage as low performance due to emitter degradation, and directs the switch controller 54 to switch from the primary emitter electrodes 22a-c to the redundant emitter electrodes 23a-c.

In yet another embodiment, the sensor 52 is an airflow sensor configured to measure the airflow created by the ion wind fan 20. If the airflow drops below a certain threshold, and remains below this threshold for longer than a predetermined time period, then the performance monitor 50 interprets this decrease in airflow as low performance due to emitter degradation, and directs the switch controller 54 to switch from the primary emitter electrodes 22a-c to the redundant emitter electrodes 23a-c.

In another embodiment, multiple air flow sensors can measure the airflow due largely to individual emitter electrodes. In such an embodiment, if—for example—the airflow associated mainly with emitter electrode 22c decreases, then the performance monitor 50 instructs the switch controller 54 to only switch from emitter electrode 22c to redundant emitter electrode 23c, while keeping emitter electrodes 22a and 22b operational.

In yet another embodiment, the sensor 52 is a temperature sensor coupled to measure the temperature of the heat source being cooled (such as a CPU), the temperature of a heatsink thermally coupled to the heat source, the temperature of the air in the vicinity of the heat source, or a combination of the above listed heat measurements. If the monitored temperature or temperatures rise above a certain threshold, and remain above this threshold for longer than a predetermined time period, then the performance monitor 50 interprets the increase in temperature as low fan performance due to emitter degradation, and directs the switch controller 54 to switch from the primary emitter electrodes 22a-c to the redundant emitter electrodes 23a-c.

In yet another embodiment, multiple temperature sensors can measure the cooling effects associated mostly with individual emitter electrodes. For example, a localized heat increase on the right side of a heatsink may be caused mostly by degradation of the right hand side emitter electrode of an ion wind fan—such as emitter 22c of ion wind fan 20. In such an embodiment, if—for example—there is a measured temperature increase attributed mainly to emitter electrode 22c, then the performance monitor 50 instructs the switch controller 54 to only switch from emitter electrode 22c to redundant emitter electrode 23c, while keeping emitter electrodes 22a and 22b operational.

In yet another embodiment, the sensor 52 is a spark sensor able to detect spark events across the ion wind fan (i.e., sparks across an emitter electrode and the collector electrode). Such a sensor can detect sparks based on an acoustic (sound) signature of a spark, an electromagnetic interference (EMI) pulse produced by the spark, or a voltage/current signature across the ion wind fan during the spark (e.g., dramatic drop in voltage/rise in current). If excessive sparking is detected—defined for example as more than a threshold number of sparks during a predetermined time interval, then the performance monitor 50 interprets the excessive sparking as low fan performance due to emitter degradation, and directs the switch controller 54 to switch from the primary emitter electrodes 22a-c to the redundant emitter electrodes 23a-c. Alternatively, if the sensor 52 can detect which emitter electrode is sparking, in one embodiment, only that electrode is switched to a redundant emitter electrode.

The performance monitor 50 can take other metrics into consideration while deciding whether to switch from one or more primary emitters to redundant emitter electrodes. For example, fan performance stability, the consistency of the fan performance, and other such metrics can be taken into account. Any combination of the above sensors, measurements, and performance metrics can also be used when determining whether to switch from a primary emitter electrode to a redundant emitter electrode, or whether to switch from a set of primary emitter electrodes to a set of redundant emitter electrodes.

Furthermore, the performance monitor 50 can monitor the measured performance metrics after the instruction to the switch controller 54 to switch to one or more redundant emitter electrodes 23. In one embodiment, if the measured performance metrics do not improve in response to the switch, the performance monitor 50 can instruct the switch controller 54 to switch back to the one or more primary emitters 22 to conserve the redundant emitters 23.

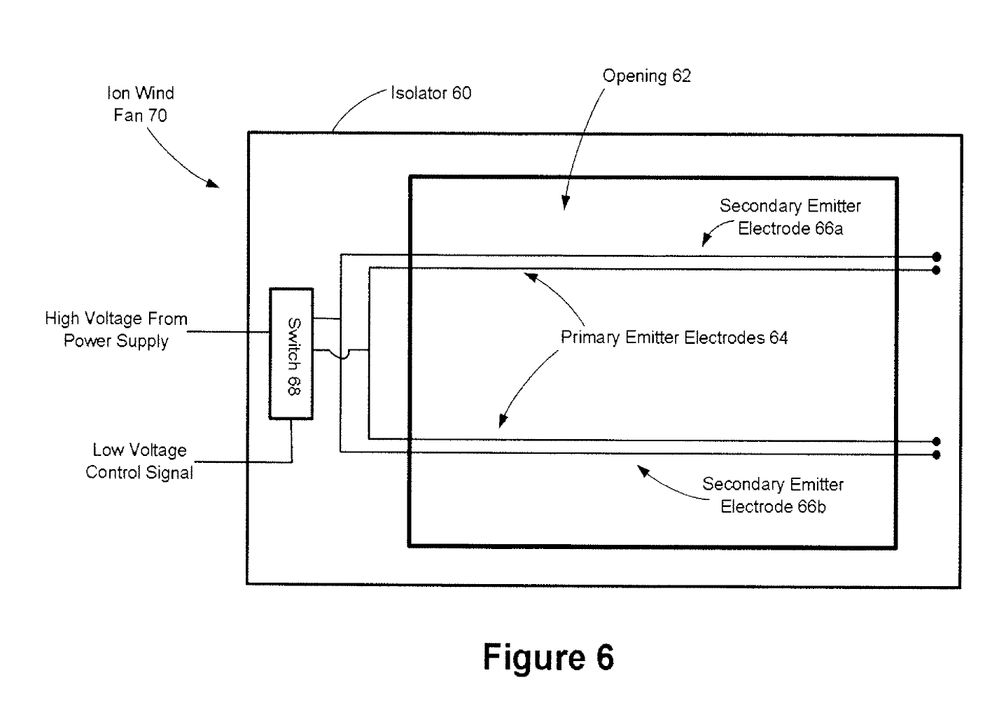

FIGS. 2-5 provide abstract block illustrations of the ion wind fan 20, the IWFPS 48, and other such components. FIG. 6 provides a frontal view of a simplified real-world ion wind fan 70 according to one embodiment of the present invention. The main components of the ion wind fan 70 are an isolator element 60 made of a dielectric material such as plastic. The isolator element has an opening 62 to allow for airflow. Other embodiments may use several smaller openings and other support structures.

This ion wind fan 70 is shown having two primary emitter electrodes 64, and would thus be sometimes referred to as a “two-channel” fan. However, the invention applies to ion wind fans having any number of emitter electrodes. The primary emitter electrodes in the embodiment shown in FIG. 6 are wire electrodes, but other types of emitter electrodes may be used.

The primary emitter electrodes 64 are coupled together by a bus and connected to switch 68 on one end, and they are attached to the dielectric isolator 60 on the other end. Secondary emitter electrodes 66 are positioned similarly, and are also connected to switch 68. Switch 68 can select whether to provide the high voltage potential from the power supply to the two primary emitter electrodes 64 or the two secondary emitter electrodes 66.

While FIG. 6 is not to scale, the secondary emitter electrodes 66 are in close proximity to their associated primary emitter electrode 64, but would be located outside of the plasma region surrounding the primary emitter electrodes 64. Close proximity can be though of as substantially as close as possible but outside of the plasma region. In other embodiments, the secondary emitter electrodes 66 are not located in close proximity to their associated primary emitter electrodes 64 and would be located well outside the plasma region.

The switch 68 is operated using a low voltage control signal as described above. When the incoming high voltage potential is applied to the primary emitter electrodes 64 by the switch 68, the secondary emitter electrodes 66 are electrically floating, as they are not connected to a power supply or ground. Similarly, when the incoming high voltage potential is applied to the secondary emitter electrodes 66 by the switch 68, the primary emitter electrodes 66 are floating.

The collector electrode is not pictured in FIG. 6 for simplicity and ease of understanding. In one embodiment, the collector electrode would roughly be the size of the opening 62 and would include air passage openings to allow for airflow. The collector electrode can be mounted to the isolator 60 so that it is held in front of the emitter electrodes.

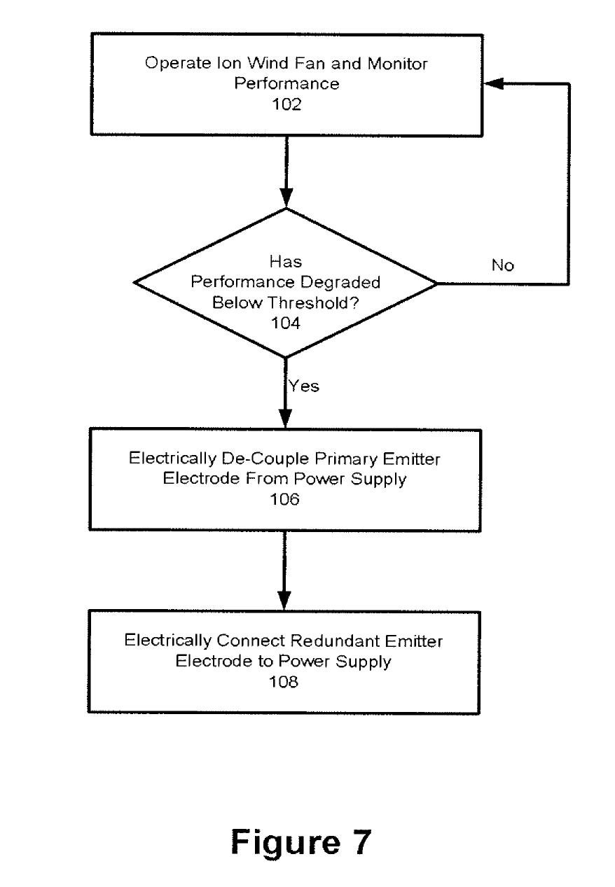

One embodiment of a process of switching from a primary to an associated redundant emitter electrode is now described with reference to FIG. 7. In block 102, the performance of an ion wind fan is monitored. As set forth above, performance of the ion wind fan can be determine using various data and sensors, such as pressure, air flow, voltage and/or current across the fan, various temperature readings, and so on. In block 104, a decision is made as to whether the performance of the fan has degraded below an acceptable threshold.

If in block 104 it is determined that the performance of the ion wind fan has not deteriorated below some predetermined threshold, then processing continues at block 102 with continued normal operation of the ion wind fan and continued performance monitoring. If, however, in block 104 it is determined that the performance of the ion wind fan has deteriorated below the predetermined threshold, then, in block 106 a primary emitter electrode being used to operate the ion wind fan is electrically de-coupled from the power supply. Also, in block 108, a redundant emitter electrode—that has been electrically floating while the primary emitter electrode was operational—is electrically coupled to the power supply. Thus, in blocks 106 and 108, provision of a high voltage potential is effectively switched from the primary emitter electrode to the redundant emitter electrode associated with the primary emitter electrode.

In the descriptions of the Figures above, the redundant or secondary electrode has been described as being associated with the primary emitter electrode. However, in other embodiments, there need not be a one-to-one association between primary and redundant emitter electrodes. For example, and ion wind can have three primary and two redundant electrodes. Similarly, an ion wind fan can have three primary and 10 redundant electrodes; e.g., the middle of the three primary electrodes may have four redundant electrodes while the side emitters may have three each. The invention is not limited to any specific number of emitter electrodes or redundant emitter electrodes.

In FIGS. 4 and 6, the high voltage switch performing the electrical de-coupling of the primary emitter electrode(s) and the electrical connecting of the redundant emitter electrode(s) is shown to be part of the ion wind fan. However, the high voltage switch can reside inside the power supply (if the power supply is physically isolated), as part of a circuit board containing the power supply, the ion wind fan, or both the power supply and the ion wind fan. The present invention is not limited to any specific location of the high voltage switch.

In the descriptions above, various functional modules are given descriptive names, such as “sensor,” “switch,” and “performance monitor.” The functionality of these modules can be implemented in software, firmware, hardware, or a combination of the above. None of the specific modules or terms—including “power supply” or “ion wind fan”—imply or describe a physical enclosure or separation of the module or component from other system components.

In the descriptions of the various embodiment of the present invention, the term “across” is sometimes used, as in “a voltage across the ion wind fan,” current across the ion wind fan,” or “across the emitter electrode and the collector electrode.” As used above, “across” the ion wind fan means across one or more emitter electrode and the collector electrode. For example, the voltage across the ion wind fan is the differential voltage between an emitter electrode (or multiple emitter electrodes) and the collector electrode.

What is claimed:

1. An ion wind fan comprising:
a primary emitter electrode; and
a redundant emitter electrode, wherein the primary emitter electrode and the redundant emitter electrode are never simultaneously operational.

2. The ion wind fan of claim 1, further comprising a second primary emitter electrode and a second redundant emitter electrode, wherein the second primary emitter electrode and the second redundant emitter electrode are never simultaneously operational.

3. The ion wind fan of claim 2, wherein the primary emitter electrode is associated with the redundant emitter electrode.

4. The ion wind fan of claim 2, wherein the primary emitter electrode and the second redundant emitter electrode are never simultaneously operational, and the second primary emitter electrode and the redundant emitter electrode are also never simultaneously operational.

5. The ion wind fan of claim 1, further comprising a set of primary emitter electrodes that includes the primary emitter electrode, a set of redundant emitter electrodes that includes the redundant emitter electrode, wherein the ion wind fan operates using either the set of primary emitter electrodes or the set of redundant emitter electrodes.

6. The ion wind fan of claim 5, wherein each electrode in the set of primary emitter electrodes is associated with an electrode in the set of redundant emitter electrodes.

7. The ion wind fan of claim 5, wherein the set of primary emitter electrodes contains the same number of electrodes as the set of redundant emitter electrodes.

8. The ion wind fan of claim 1, further comprising a high voltage switch configured to switch power from the primary emitter electrode to the redundant emitter electrode.

9. The ion wind fan of claim 1, wherein the primary emitter electrode is electrically decoupled from a power supply in response to a degradation of the primary emitter electrode, and the redundant emitter electrode is electrically coupled to the power supply in response to the degradation of the primary emitter electrode.

10. The ion wind fan of claim 1, wherein the redundant emitter electrode is located outside of a plasma region of the primary emitter electrode.

11. The ion wind fan of claim 1, further comprising a second redundant emitter electrode, wherein at most one of the primary emitter electrode, the redundant emitter electrode, and the second redundant emitter electrode are simultaneously operational.

12. A thermal management subsystem comprising:
a power supply to provide a high voltage potential;
an ion wind fan having at least one primary emitter electrode and at least one redundant emitter electrode; and
a high voltage switch configured to switch the high voltage potential provided by the power supply between the at least one primary emitter electrode to the at least one redundant emitter electrode.

13. The thermal management subsystem of claim 12, further comprising a performance monitor module to determine whether a performance of the ion wind fan has fallen below a threshold, wherein the performance monitor module causes the high voltage switch to switch the high voltage potential provided by the power supply from the at least one primary emitter electrode to the at least one redundant emitter electrode if the performance of the ion wind fan is determined to have fallen below the threshold.

14. The thermal management subsystem of claim 13, further comprising a sensor, wherein the performance monitor determines whether the performance of the ion wind fan has fallen below the threshold using data from the sensor.

15. The thermal management subsystem of claim 14, wherein the sensor comprises at least one of a flow sensor, a current sensor, a voltage sensor, a spark sensor, and a heat sensor.

16. The thermal management subsystem of claim 12, wherein the at least one redundant emitter electrode is not located in a plasma region of the at least one primary emitter electrode.

17. The thermal management subsystem of claim 12, wherein the high voltage switch is collocated and part of the power supply.

18. The thermal management subsystem of claim 12, wherein the high voltage switch comprises one or more optical couplers.

19. An ion wind fan comprising:
a plurality of emitter sets, each emitter set of the plurality of emitter sets comprising a plurality of emitter electrodes, wherein at most one emitter electrode from each emitter set is active when the ion wind fan is operational.

20. A method comprising:
monitoring one or more performance metrics associated with an ion wind fan;
inferring degradation of one or more primary emitter electrodes based on the one or more monitored performance metrics; and
operating the ion wind fan using one or more redundant emitter electrodes instead of the one or more primary emitter electrodes in response to the inferred degradation of the one or more primary emitter electrodes.

21. The method of claim 20, wherein operating the ion wind fan using one or more redundant emitter electrodes instead of the one or more primary emitter electrodes comprises electrically decoupling the one of more primary emitter electrodes from a power supply, and electrically coupling the one or more redundant emitter electrodes to the power supply.
